(19) United States
(12) Patent Application Publication
(10) Pub. No.: US 2009/0198516 A1
(43) Pub. Date: Aug. 6, 2009

(54) SYSTEM AND METHOD OF MANAGING DIABETES EMPLOYING AN INTERACTIVE WEBSITE

(76) Inventor: David Greenholtz, Park City, UT (US)

Correspondence Address: FULWIDER PATTON LLP, 6060 CENTER DRIVE, 10TH FLOOR, LOS ANGELES, CA, 90045, US

(21) Appl. No.: 12/026,122

(22) Filed: Feb. 5, 2008

(51) Int. Cl. G06Q 50/00

(52) U.S. Cl. 705/3

(57) ABSTRACT

A method and system for managing diabetes employing an interactive website for processing data through an algorithm to correlate the lifestyle factors with stored vital statistics to produce a real-time assessment of diabetes management such as glucose levels. The website gives the user an interactive and real-time analysis of blood sugar and other daily factors via instant access such as by an internet interface on a personal computer or cell phone, with the ability to monitor one's individual performance, as well as viewing sample data from the same demographic group. A numerical score is displayed based on all input factors, and a predictive feature allows forecasts based on hypothetical changes in lifestyle conditions.

### BACKGROUND OF THE INVENTION

According to the National Institute of Diabetes and Digestive and Kidney Diseases, in 2005 an estimated 20.8 million people in the United States, 7.0 percent of the population, had diabetes. Diabetes is a disorder of metabolism, i.e., the method in which the body burns sugars from digested food for growth and energy. Food is broken down into glucose, the primary form of sugar in the blood. Glucose serves as the main source of fuel for the body. When food is digested, the glucose passes into the bloodstream, where it is absorbed and used by cells for growth and activity. For glucose to get into cells, however, a substance called insulin must be present. Insulin is a hormone produced naturally by the pancreas.

In most cases, the pancreas automatically produces the right amount of insulin to move glucose from the blood into the body's cells. However, in people with diabetes, the pancreas either produces too little or no insulin, or the cells do not respond appropriately to the insulin that is produced. As a result, glucose builds up in the blood but is not consumed by the cells in an appropriate proportion, causing the excess glucose to overflow into the urine and pass out of the body. The body is thus deprived of its main source of energy, and the build-up of sugar can cause life threatening complications such as heart disease and strokes, not to mention blindness and amputation of limbs.

Diabetes occurs in primarily three forms. Type 1 diabetes is an autoimmune disease. An autoimmune disease results when the body's system for fighting infection (the immune system) turns against a part of the body. In diabetes, the immune system attacks and destroys the insulin-producing beta cells in the pancreas. The pancreas then produces little or no insulin. Type 1 diabetes patients must take insulin daily to survive. Type 1 diabetes accounts for about 5 to 10 percent of diagnosed diabetes in the United States. It develops most often in children and young adults, but can appear at any age. Symptoms of type 1 diabetes usually develop over a short period, although beta cell destruction can begin years earlier. Symptoms may include increased thirst and urination, constant hunger, weight loss, blurred vision, and extreme fatigue. If not diagnosed and treated with insulin, a person with type 1 diabetes can lapse into a life-threatening diabetic coma, also known as diabetic ketoacidosis.

The most common form of diabetes is type 2 diabetes. About 85 to 90 percent of people with diabetes have the type 2 condition. Type 2 diabetes is most often associated with older age, obesity, heredity, previous history of gestational diabetes, physical inactivity, and certain ethnicities. About 80 percent of people with type 2 diabetes have weight issues. In type 2 diabetes patients, the pancreas is usually producing enough insulin, but the body cannot use the insulin effectively, a condition called insulin resistance. After several years of ineffective insulin usage, the body's natural insulin production begins to decline. The result is the same as for type 1 diabetes, that glucose builds up in the blood and the body cannot make efficient use of its main source of fuel. The symptoms of type 2 diabetes typically develop gradually, and may include fatigue, frequent urination, increased thirst and hunger, weight loss, blurred vision, and slow healing of wounds or sores.

Some women develop gestational diabetes in the mid to late stages of pregnancy, a third type of diabetes. Although this form of diabetes usually disappears after the birth of the baby, women who have had gestational diabetes have a 20 percent chance of developing type 2 diabetes within 5 to 10 years. Maintaining a reasonable body weight and being physically active may help prevent development of type 2 diabetes in women who have had gestational diabetes. As with type 2 diabetes, gestational diabetes occurs more often in some ethnic groups and among women with a family history of diabetes. Gestational diabetes is caused by the hormones of pregnancy or a shortage of insulin. Women with gestational diabetes may not experience any symptoms.

Many people who do not have diabetes still suffer from a condition referred to as pre-diabetes. Pre-diabetes is becoming more common in the United States, according to new estimates provided by the U.S. Department of Health and Human Services. About 40 percent of U.S. adults ages 40 to 74, approximately 41 million people, had pre-diabetes in 2000. New data suggest that at least 54 million U.S. adults had pre-diabetes in 2002. Many people with pre-diabetes go on to develop type 2 diabetes within 10 years. People afflicted with pre-diabetes may have blood glucose levels higher than normal but not high enough to be diagnosed as diabetic. This condition raises the risk of developing type 2 diabetes, heart disease, and stroke. Pre-diabetes is also called impaired fasting glucose (IFG) or impaired glucose tolerance (IGT), depending on the test selected to diagnose it.

Studies have shown that people exhibiting pre-diabetes can lower their risk of developing diabetes by losing 5 to 7 percent of their body weight through diet and increased physical activity. A major study of more than 3,000 people with IGT found that diet and exercise resulting in a 5 to 7 percent weight loss, about 10 to 14 pounds in a person who weighs 200 pounds, lowered the incidence of type 2 diabetes by nearly 60 percent.

Diabetes prevalence in the United States is likely to increase for several reasons. First, due to fast food, lack of exercise, and a sedentary lifestyle, a larger percentage of Americans are becoming increasingly overweight. Second, a large segment of the population is aging. According to recent estimates from the Centers for Disease Control and Prevention (CDC), diabetes will affect one in three people born in 2000 in the United States. The CDC also projects the prevalence of diagnosed diabetes in the United States will increase 165 percent by 2050.

Before the discovery of insulin in 1921, patients with type 1 diabetes died within a few years after diagnosis. Although insulin is not considered a cure, its discovery was the first major breakthrough in diabetes treatment. Today, healthy eating, physical activity, and taking insulin are the basic therapies for type 1 diabetes. The amount of insulin must be balanced with food intake and daily activities. Blood glucose levels must be closely monitored through frequent blood glucose testing. People with diabetes also monitor their blood glucose levels several times a year with a laboratory test called the A1C. Results of the A1C test reflect average blood glucose over a 2- to 3-month period.

Healthy eating, physical activity, and blood glucose testing are the basic management tools for people with diabetes. In addition, many people with type 2 diabetes require oral medication, insulin, or both to control their blood glucose levels. Moreover, managing diabetes is more than keeping blood glucose levels under control, it is also important to manage blood pressure and cholesterol levels through healthy eating, physical activity, and use of medications since people with diabetes are at a higher risk of developing heart disease and strokes.

Based on the foregoing, it is imperative that people with diabetes take responsibility for their day-to-day care. Much of the daily care involves maintaining blood glucose levels within a selected range, neither too low or too high. Should the blood glucose level drop too low—a condition known as hypoglycemia—a person may become shaky, disoriented, convulsive, and if not treated quickly, the person may lose consciousness and even lapse into a coma. On the other hand, if a person's blood glucose level rises too high, a condition known as hyperglycemia, a host of symptoms can result including nausea, blurred vision, dizziness, fatigue, and reoccurring infections.

One problem that persists in the treatment of diabetes is the fact that as many as six million people living in the United States have diabetes and do not even know it. This lack of knowledge about the disease can have devastating effects on those inflicted, who could be treating and controlling the disease but instead may be worsening its effects and placing their body at risk by not taking appropriate action. For those who are unaware, this can be catastrophic as complications from uncontrolled diabetes leads to heart disease, blindness, amputation of limbs, and kidney damage. However, there is a void in the present modes of managing this disease where people of all economic levels and backgrounds can obtain answers to their questions and conduct a self evaluation to determine whether they may have this disease and what steps should be taken to further investigate and manage the disease.

The goal of diabetes management is to keep levels of blood glucose, blood pressure, and cholesterol as close to the normal range as safely possible. Diabetics can check their blood sugar in several ways: 1) using a small, portable glucose monitor that can test a person multiple times a day; and 2) using a A1C test. However, the latter is a two to three month average and usually requires administering by a health care provider. Also, the results do not reflect recent changes that the patient may have incorporated in to the management of the disease, such as diet, exercise, or medication.

Keeping blood glucose levels close to normal reduces the risk of developing major complications of diabetes. However, patients often lack the tools, experience, and resources to manage their own care, necessitating frequent medical visits. The uncertainty can also lead to confusion, anxiety, and even depression over the disease and the unfamiliarity with the steps needed to manage the condition. Some prior art methods have been directed to this concern over personal management of diabetes care.

U.S. Publication No. 2006/002827883 by Turgiss et al. discloses a system using a web site interface for gathering data from a survey or questionnaire of patients for monitoring health and fitness including the monitoring of diabetes. The data includes measured vital statistics such as blood pressure, body fat and body mass index (BMI). Other data such as weight, height, and age are manually entered into the website. A diabetes patient interfaces with the website and uses the system by entering blood glucose results that are displayed in a two-dimensional graphical result output by the web site showing the blood glucose results history. Results and data are stored in a patient history file for subsequent review and assessment.

U.S. Publication No. 2004/0054263 by Moerman et al. discloses a wireless system for treatment and management of diabetes employing blood glucose test and telecommunications devices. In this system, a wireless phone incorporates an interface with a glucose meter where a patient administers the glucose test and the results are transmitted through the wireless home into a counseling center were the results are processed. Upon processing, a treatment or diagnosis is returned via a text message back to the user cellular phone through the wireless system.

U.S. Publication No. 2003/0011646 by Levine et al. discusses the formation of a virtual clinic for managing chronic illnesses using telecommunications, including diabetes. A virtual clinic is disclosed replicating the experience of a patient visiting a health-care management facility using a team of physicians contacted online who are able to recommend treatments for chronic illnesses based on the history and test results of members. Health-care history and self administered test results are user pre-input and health care professionals are able to view the histories and test results, diagnose from the input data and recommend treatments completely through a virtual setting. Additionally, doctors' visits and scheduled appointments are tracked and reminders are sent to the client detailing the time between scheduled events. Medical events such as hypoglycemic events and test results such as average glucose levels can be sent as messages or alerts within a user's website file page. Results of diabetes in the glucose in insulin levels are given in standard two-dimensional or tabular formats (FIG. 17).

U.S. Publication No. 2001/0039503 by Chan et al. describes a method and system for managing health and wellness programs for patients afflicted by chronic disease using multiple computing and storage devices located remotely from each other. Software manages data input, processes, and stores data for an individual patient. Personal health and medical records are input to the system and are updated with current test results transmitted by individuals through devices such as personal digital assistants or cellular telephones. Recently inputted test results are processed in the system and forwarded to participating medical professionals who generate customized recommendations. The system in part targets diabetes sufferers by providing insulin monitoring and having blood glucose results sent wirelessly to the network that are processed and a diagnosis is generated as a textual recommendation transmitted back to the patient.

U.S. Publication No. 2006/0010098 to Goodnow et al. discloses a web-based diabetes care system that stores diabetes care data relating to multiple diabetics. www.sidiary.org is a website that discloses the sale of diabetes management software for tracking input blood glucose levels. The software also includes analysis, trends, and graphical feedback based on glucose readings. A data entry interface allows different data storage machines to synchronize data. www.diabetesonline.com is a website that also discloses diabetes management software for use on a personal computer. An “Insulin Therapy Analysis” portion of the software allows the user to input food, insulin, and exercise along with three personal constants to show predicted blood glucose levels throughout the day. www.mangesius.com is a website that markets software for real-time personalized metabolic management. The homepage discloses a user interface with options that appear to allow users to enter data related to food, insulin, and activity and users can select other options to plot data.

None of the cited references teach or suggest combining the features into one system to provide a unified result of the diabetes factors and conditions in a real-time evaluation and response.

### SUMMARY OF THE INVENTION

The present invention is directed to method of managing diabetes employing an interactive website for tracking various factors that effect a person's diabetes condition and can measure the person's progress of diabetes management against trends developed from the patient's history as well as a population of other diabetics. The system, which allows twenty four hour access from any location using all types of computer, cellular, and PDA devices, allows a patient to rate their overall lifestyle management with the capacity to dynamically see the effects of specific changes to diet, exercise, insulin intake, and so forth. The web site also establishes personalized targets for sugar ranges, caloric intake, exercise, and overall lifestyle parameters, which allows the user to manage his or her diabetes in an effective and reliable manner while reducing the reliance and frequency of medical visits. The site also helps diagnose people with pre-diabetes, and provide information that can alleviate anxiety and uncertainty about managing the disease.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is an exemplary home page of the web site of the present invention; and

FIG. 2 is an exemplary user page of the web site of FIG. 1.

### DETAILED DESCRIPTION OF THE PREFERRED EMBODIMENTS

The present invention comprises a system and method to treat and monitor the overall health of a diabetes patient by providing a remotely accessible database for gathering and processing patient data, including lifestyle factors, to produce real-time feedback of everything from estimated insulin levels to how exercise will affect daily blood sugar numbers. The system, dubbed the “KeyVive” system, empowers individuals to actively control their diabetes through food, exercise, stress, and medication monitoring to achieve a healthy lifestyle. The KeyVive system centers around an all-access web site that allows users to review the site and enter data using all manners of personal communication devices such as personal computers, hand held devices, cell phones, and the like. The user-friendly layout of the site includes forums for personal discussion, a video-clip area where product, drug companies and subscribers can post information and personal stories, and information portals for accessing diabetes related information from care providers and diabetes associations. The site also provides informative content, including an extensive database of medications and foods, and how they affect blood sugar levels, as well as a help section for persons who think that they or a family member may have diabetes, and parents of kids with diabetes.

The site includes many informational databases to assist the user in maintaining a healthy lifestyle. For example, an extensive food database incorporates thousands of listings along with nutritional values, compiled from public information sources. Restaurants and other eating establishments are also included. This gives a user the ability to understand food portions and see their daily calorie calculation for weight loss or gain, carbohydrates for counting and overall averages based on recommended daily allowances. In addition, a prescription and over-the-counter medication database is provided so users can see how medications will impact their body. Many people with diabetes have prescriptions they use in conjunction with insulin. While setting up a profile, an individual can choose from a drop-down list of prescriptions and over-the-counter medications, and the prescription database gives potential side effects, drug interactions, and blood sugar effects. In addition, an exercise database is provided to assist the user in developing a healthy exercise plan to maintain a healthy lifestyle. Here, a user will be able to enter various types of exercise from weight training and cardio vascular workouts to playing golf, hiking and bike riding. The database in turn will give information such as how many calories were burned per amount of time entered. Additionally, the exercise database will provide advantages and disadvantages about each particular type of exercise.

A key feature of the KeyVive website is a unique 100 scale rating system that uses several factors central to maintaining healthy control of diabetes. The rating system is preferably measured on a scale ranging from 1 to 100 using a statistical formula to provide diabetics with a numeric personal assessment. The rating system for each user can be specific to a time of day, week, and month, and incorporate multiple variables in determining a person's overall healthy lifestyle success. Such variables include insulin usage, glucose readings, food intake in the form of calories, carbohydrates, proteins, etc., exercise, height, weight, activity level, stress level, and doctor recommendations. Some of these variables are relatively stable (such as height), and some variables require daily or even hourly updates (caloric intake). The algorithm stores each input for a particular user and outputs a numeric value between one and one hundred. This value can be used by the diabetic to evaluate a present status without a blood test or doctor's visit.

The algorithm and statistical formulas for calculating the KeyVive rating begins with a baseline of information that the individual develops as he or she inputs his information. The baseline will include time frames (day, week, month, etc.) once the variation on the database is less than 10% or has been deemed stable. Typical factors and their associated variables are listed below:
S=CALORIES
T=CARBOHYDRATES (CALCULATION OF COMPLEX, SIMPLE CARBS)
U=MINUTES OF EXERCISE (CARDIOVASCULAR &WEIGHT TRAINING)
V=UNITS OF INSULIN
W=STRESS LEVEL & ACTIVITY LEVEL
X=GLUCOSE LEVEL
Y=MEDICATIONS
Z=PERSONAL PROFILE (WEIGHT, AGE, HEIGHT, ETHNICITY)

One or more of the above listed factors has an elasticity associated in the algorithm. A factor's elasticity indicates the responsiveness of one variable in response to changes in another variable. For example, glucose levels may be intimately tied to activity levels and medications of the user. Certain medications also can affect blood sugar levels. The system determines the interaction of these factors and assigns an elasticity to help predict future behavior.

To begin the process, a new user joining or subscribing to the site will follow a general set-up routine that initiates the user to the site and solicits the information needed to establish a baseline. The set-up begins by the user activating a user name and password that will gain access to the site, and establish an account with the site administrator. The user will then create a profile and enter personal information such as height, weight, age, type of diabetes (if known), etc. The user will also be prompted to enter any medications that the user is presently taking and the amount, as well as typical diet, exercise, doctor's orders, and customary food intake. Other information needed to complete the baseline is entered at this time or over the course of time.

With the registration complete and the baseline information entered (e.g., amount of insulin used, exercise regimen, diet, stress level, etc.), the user then continues to access the site each day and input his or her daily activities. The web site manages the user's account and the data is continuously stored and analyzed until a normalized baseline of the diabetes behavior is established. The variables identified above are incorporated into the algorithm's formula that will determine a score of how well that individual is achieving an overall healthy lifestyle goal, where a score of 100 is considered a perfect score. This value is not simply derived by equal percentages of each variable. Rather, the variables are analyzed by each individual's progress and factors are then appropriately weighted and determined, taking into account the elasticity of certain variables. As a result, some individuals will display improvements in health when exercising more while others may have better results with better insulin usage. The system accounts for the fact that two users with identical profiles could still have different results.

The algorithm also computes a recommended food intake such as suggested calories or carbohydrates from the personal information and establishes exercise guidelines based on statistical data. The website, during initial set-up, asks the user to configure a portable communication device, such as a cell phone, so that the website can be accessed anywhere the patient goes, including restaurants, vacations, travel, and the like. Thereafter, the user can begin to input real-time data as it happens through the course of the day, from exercise to food consumption to stress levels, to sleep durations. In addition, the user may create and store profiles of a typical day of meals, exercise, and insulin use. Many individuals follow a usual routine, and storing these routines in a profile can make inputting the daily data faster and easier.

This system further includes a predictive feature whereby a user can ask “what if” a certain condition is changed, and How Will This Change His/Her Personal Rating? This allows each person to consider how changes in his or her lifestyle will affect his or her diabetes. Changes could include an increase or decrease in exercise, changes to caloric and carbohydrate intake, medication changes, and other lifestyle changes. Once a user makes a future assumption (i.e. “What if I exercise an extra two hours a week?”), the system will calculate those changes and provide a projected KeyVive rating and a daily blood sugar average. This projection is based upon the user's own personal history, a statically comparable profile for the entire database (i.e., others in the database having a similar individual profile), and based on the entire database.

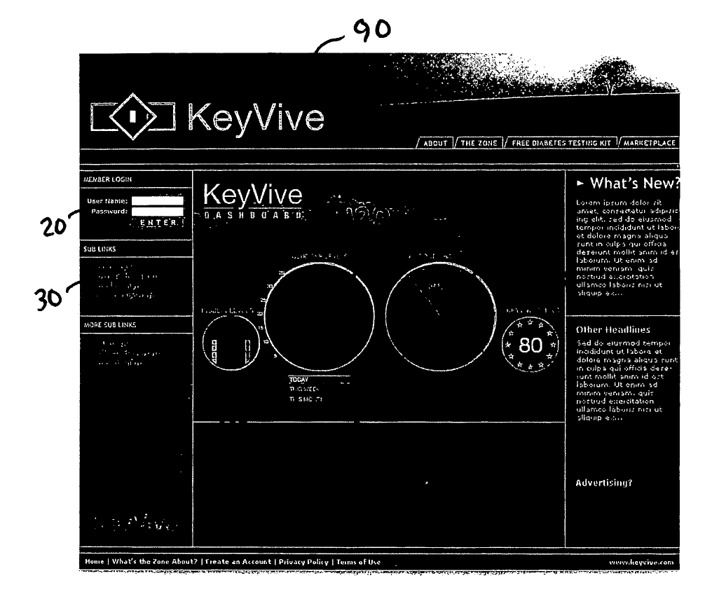

A key feature of the present invention is the large targeted database of the diabetes population where trends can be analyzed. This system will maintain a database of users and will collect their data to aid in projections and provide comparative data. In this manner, the rating system is supported by historical data built and observed from other changes to other individuals as well as the present user. Collective data can be viewed on a “Snapshot” page (see FIG. 2), where users will be able to see vital information by day, week, month or yearly comparisons. The snapshot page allow a user to see many variables at once, thus providing a unique view of their life with diabetes.

This web-based product is designed to help individuals control their sugar levels and build a healthy lifestyle. Incorporating unique tools and analysis, the goal is to help build a strong personal foundation for diabetes management. Based on areas of need, targeted information will be tailored to suggest improvements. The site incorporates graphical views and an easy-to-use input system. Entry can be completed on a computer, a cell or wireless phone. In other preferred embodiments, access is available via touch-tone or by fax using an OCR application for individuals who may be computer challenged.

The ability to enter data from a remote location allows much greater flexibility and facilitates a more comprehensive data collection by permitting data entry anywhere and anytime. Utilizing simple terminology, users will be able to enter daily information over the telephone, such as insulin, food, and exercise. The system recognizes short cuts, medical terms, and misspelled words, making it easier for individuals to enter data on a cell phone. The user can also input a glucose number along with a question mark (“?”) and the web site will interpret the question and display a glucose history along with remedial actions if necessary. The site can also display doctor recommended insulin dosages for a particular food or meal, where the user may enter a “?” if they are unsure of how much insulin is required.

Another key feature of the present invention is a pre-diabetes area for aiding those who may be in this stage of the disease. Prior to being diagnosed, many people wait too long time before seeing a doctor. Often, a drastic event must take place in order for individuals to seek medical help. The pre-diabetes area allows an individual who suspects that he is exhibiting diabetes warning signs to receive a free testing kit via overnight delivery. The monitoring system is typically partnered with a glucose monitoring company to distribute sample kits with simple testing instructions. In addition, a diabetes center and local doctor group contact area is partnered for referrals in exchange for information and input into the system. The user will follow a protocol and keep the test results for their doctor to review. In the event of an extremely high glucose reading, the user can take action immediately, possibly saving a life or avoiding an extreme medical condition.

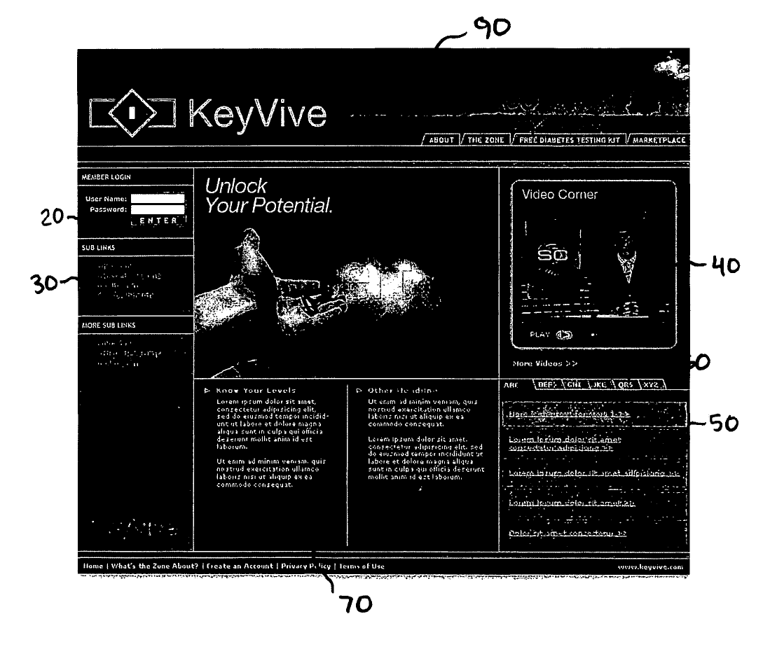

FIG. 1 illustrates an exemplary home page for the web site of the present invention. A user sign-in box 20 is provided in the left hand corner where a user can enter a username and password. Below the user sign-in box is an information box 30 containing links to various information related to diabetes. On the right hand side is a video display screen 40 where videos of users, health care professionals, and news clips related to diabetes can be viewed. An index of various information is located below the video screen 40 in a question or topic box 50, where alphabetical tabs 60 help to index the information. Lead stories 70 can be presented in the lower middle portion of the web page, with a graphical welcome image 80 displayed prominently above the lead stories. On the title banner 90 are a series of tabs 100 that take the reader to a marketplace where various commercial goods and services are available, a free diabetes test kit can be ordered, and other information about the site in general and its administrators.

FIG. 2 is a user screen that pops up after the user logs on with the correct username and password. This screen includes graphical representations of insulin levels 110, glucose levels 120, and fat/carbs/calories breakdown 130. A KeyVive score 140 corresponding to a value between one and one hundred is an evaluation of the patient's present status using the one hundred point scale, taking into account all of the factors discussed above using elastic variables. This dashboard view of the various conditions that effect the person's diabetes represents a unique all-purpose view in an easy-to-read format that assimilates all of the data for the patient. A pull-down menu 150 can adjust the dashboard view from day to week to month or other, depending on the view desired by the patient. This provides a quick and easy way to measure a progress and development of the management of the disease.

From the foregoing, one can appreciate that the present system and method provides many advantages and benefits not seen in the prior art, including the ability to monitor one's present diabetic condition and glucose level in real time using a computer, cell phone, PDA, or other device. Moreover, the system's capacity to respond to “what if” scenarios with predictions enables a user to evaluate changes to his or her current lifestyle. Finally, the unique manner in which the factors are combined using interrelations between factors to develop an elasticity of variables achieves superiority over prior art methods.

The foregoing descriptions and discussions should be interpreted as illustrative only, and should not limit the scope of the present invention to the just-described embodiments. Rather, one of ordinary skill in the art will envision many variations and modifications to the above described embodiments and the invention should be deemed to include said modifications and variations. Accordingly, the scope of the present invention is properly measured by the words of the appended claims, construed using their ordinary meanings, and not by any particular description or embodiment described herein.

I claim:

1. A system for managing diabetes patient related data in real time using an interactive website comprising:
a database for storing a population of diabetics' medical information;
an analytical means for applying an algorithm to a set of patient input data corresponding to a baseline condition, said analytical means determining a present condition and further determining a predictive condition based on proposed changes in said input data and said baseline condition;
means for remotely entering daily diabetic information data from said patient; and
a graphical interface for displaying a present rating of a diabetic condition based on said baseline condition and said daily diabetic information, and further displaying said predictive condition in response to a request for evaluation of proposed changes in said input data.

2. The system for managing diabetes patient related data of claim 1, wherein the analytical means produces a present condition in real-time and the present condition is transmitted back to the patient remotely in real time.

3. The system for managing diabetes patient related data of claim 1, wherein the present condition is displayed as a score between one and one hundred based on a plurality of factors relating to a glucose level.

4. The system for managing diabetes patient related data of claim 3 wherein said at least one of said plurality of factors has an elasticity associated with another one of said plurality of factors.

5. The system for managing diabetes patient related data of claim 1, wherein the graphical interface further displays historical data of various input data of the patient for tracking performance of the patient.

6. The system for managing diabetes patient related data of claim 1, further comprising a video display screen for presenting video to the patient wherein said video is selected from user feedback, news footage, and sponsor messages.

7. The system for managing diabetes patient related data of claim 1, further comprising a food database for presenting information on foods and restaurant products in response to a patient inquiry.

8. The system for managing diabetes patient related data of claim 1, further comprising an activity database for presenting information on exercise and activities in response to a patient inquiry.

9. The system for managing diabetes patient related data of claim 1, further comprising a pre-diabetes screening tab for displaying information on diagnosing and treating pre-diabetes in response to a user inquiry.

10. The system for managing diabetes patient related data of claim 1, further comprising a medication database for presenting information on prescription and over-the-counter medications and interactions therebetween in response to a patient inquiry.

11. The system for managing diabetes patient related data of claim 3, wherein said plurality of factors is selected from the group comprising insulin usage, glucose readings, food intake, activity levels, medications taken, and stress levels.

12. The system for managing diabetes patient related data of claim 1, further stored daily profiles of common patient factors for entering into said database to save time in entering patient data.

13. The system for managing diabetes patient related data of claim 1 further comprising a snapshot page for displaying a plurality of factors on said graphical interface corresponding to a comprehensive view of the patient's present condition.

14. The system for managing diabetes patient related data of claim 1, wherein said analytical means employs an algorithm that utilizes both a patient's personal historical information and data from population of diabetics' medical information.

15. A method for determining and displaying a diabetes patient's condition in real time based upon patient input, comprising the steps of:
providing an interactive website to communicate with said patient remotely;
surveying said patient using said interactive website to establish a baseline condition of said patient;
configuring a communication link with said patient to receive input from said patient remotely and storing said patient input in a database;
receiving daily data from said patient on specific factors relating to said condition;
providing an analytical means for determining a present condition of said patient based on a history of said patient input, and displaying on said patient's remote display a condition rating based on the determination; and
determining a predictive condition of said patient using said analytical means in response to a patient inquiry, where said predictive condition is based on a specified change in said specific factors.

16. The method of determining and displaying a diabetes patient's condition of claim 15, wherein said analytical means also determines the present condition of said patient and said predictive condition based on information stored in a database based on a population of diabetics' stored information on said database.

17. The method of determining and displaying a diabetes patient's condition of claim 15, wherein said condition rating is a value between one and one hundred based on a plurality of factors assessed by said analytical means.

18. The method of determining and displaying a diabetes patient's condition of claim 17, wherein said analytical means assigns an elasticity to at least one of said plurality of factors in connection with at least one other of said plurality of factors.

19. The method of determining and displaying a diabetes patient's condition of claim 15, wherein said patient creates a daily profile of common factors and inputs into said database a daily profile when appropriate to save time.

20. The method of determining and displaying a diabetes patient's condition of claim 15 further comprising displaying a historical response of patient input in a time frame selected by the patient from list comprising day, week, and month.

21. The method of determining and displaying a diabetes patient's condition of claim 15 further comprising the step of displaying a snapshot page in response to a patient inquiry, where said snapshot page includes information on a plurality of factors that affect the patient's condition.

22. The method of determining and displaying a diabetes patient's condition of claim 21, wherein said plurality of factors are selected from: insulin usage, glucose readings, food intake, activity levels, and stress levels.
